(19) United States
(12) Patent Application Publication
(10) Pub. No.: US 2002/0168488 A1
(43) Pub. Date: Nov. 14, 2002

(54) Knitted multi-property protective sleeve

(76) Inventors: Harry F. Gladfelter, Kimberton, PA (US); Janice R. Maiden, Flourtown, PA (US); Danny E. Winters, Downingtown, PA (US); Thomas B. Conaghan, West Bloomfield, MI (US)

Correspondence Address: Synnestvedt & Lechner LLP, Suite 2600, 1101 Market Street, Philadelphia, PA, 19107-2950, US

(21) Appl. No.: 10/121,010

(22) Filed: Apr. 11, 2002

Related U.S. Application Data
(60) Provisional application No. 60/284,027, filed on Apr. 16, 2001.

(51) Int. Cl. B32B 1/08; B65D 1/00; F16L 9/10; A47G 19/22; B28B 21/00; B28B 21/72; B29D 22/00; B29D 23/00; B28B 23/08; D03C 13/00; F16L 1/00

(52) U.S. Cl. 428/34.4; 428/36.1; 428/36.9; 139/35

(57) ABSTRACT

A protective sleeve for covering elongated substrates is disclosed. The sleeve is knitted from a combination of first and second filamentary members having different properties from one another. The filamentary members are plated so that the filamentary members having properties compatible with the substrate are positioned predominantly on the inner surface of the sleeve facing and engaging the substrate. Filament properties include heat resistance, high-tensile strength, resistance to abrasion, chemical attack and damping capability. Ribs are integrally knitted lengthwise along the sleeve to form insulating air pockets. The ends of the sleeve are finished with welts to prevent unraveling.

### RELATED APPLICATION

This application is based on and claims priority to U.S. Provisional Patent Application No. 60/284,027, filed Apr. 16, 2001.

### FIELD OF THE INVENTION

This invention relates to sleeving for covering and protecting elongated substrates, the sleeving having different surfaces with different properties compatible with the substrate and the environment of the sleeve.

### BACKGROUND OF THE INVENTION

Protective sleeving for covering elongated substrates must often perform several functions and have multiple different properties and characteristics which allow such functions to be performed effectively and efficiently. For example, it may be desired to provide a durable, protective sleeve for covering a glass substrate such as an automobile windshield, allowing it to be safely transported and handled prior to installation. The inner surface of such a sleeve should be compatible with the substrate in some meaningful way. For example, the inner surface should not scratch or adhere to the glass and should allow the substrate to be removed easily. Such properties are not necessary for the outer surface of the sleeve however, but other properties, such as durability, tensile strength, resistance to moisture or abrasion resistance may be desired for the outer surface.

In another example, protective sleeve may be needed to perform an insulating function for an elongated substrate such as conduit used in automobile exhaust gas recirculation systems. Pollution emitted from internal combustion engines may be reduced by exhaust gas recirculation (EGR), wherein a small amount of exhaust gas is mixed with the air-fuel charge entering the cylinder. The presence of exhaust gas mixed with the fuel-air charge tends to retard the combustion of the fuel during the power stroke, absorbs heat and thereby reduces the amount of oxides of nitrogen formed during the combustion process.

EGR systems require that conduit be routed through the engine compartment in order to conduct the exhaust gas from the exhaust manifold back to the intake manifold. The exhaust gases from the exhaust manifold are very hot, typically on the order of 1000° F. Thus, the conduit carrying these gases will tend to be hot also, and this can cause problems within the engine compartment. Unless somehow insulated, the hot conduit radiates heat which tends to blister adjacent painted surfaces, melt nearby plastic and rubber components and also presents a serious burn hazard to technicians working on the engine.

Insulative coverings for EGR conduit often require sophisticated coatings on their inner surfaces to protect them against the high operating temperatures of the EGR systems. In addition to high temperatures, the coverings are also subjected to a harsh vibrational environment and must endure hundreds of thousands of vibrational cycles without cracking, splitting or coming loose from the conduit. Furthermore, the conduit conventionally has flanged ends for connecting to the various manifolds and the EGR valve, the flanged ends also being hot but being difficult to accommodate by a wrapped insulating sleeve for example. EGR conduit tends to be any shape but straight and may be bifurcated as well, thus, presenting further challenges to the application of insulation in a convenient, cost-effective manner.

There is clearly a need for an insulative sleeve which is readily adaptable to various complicated shapes and which can provide desirable properties compatible with the substrate as well as with other requirements needed to withstand the expected environment for the sleeve.

### SUMMARY AND OBJECTS OF THE INVENTION

The invention concerns a sleeve for covering an elongated substrate. The sleeve comprises an inner surface positionable to face and surround the substrate and an outer surface positionable to face away from the substrate. The sleeve is formed from a plurality of first filamentary members interlaced with a plurality of second filamentary members. The first filamentary members have properties compatible with the substrate and are positioned predominantly on the inner surface of the sleeve for engaging the substrate. The second filamentary member have properties different from the first filamentary members and are positioned substantially on the outer surface of the sleeve.

For example, if the substrate comprises an elongated heat source such as an EGR conduit which is to be insulated, the sleeve is formed from a plurality of heat-resistant first filamentary members interlaced with a plurality of second filamentary members. The heat-resistant first filamentary members are positioned predominantly on the inner surface for engaging the heat source, and the second filamentary members are positioned substantially on the outer surface remote from the heat source. The second filamentary members are chosen to have properties different from the first filamentary members, such as abrasion resistance, or vibration damping.

Preferably, the first and second filamentary members are interlaced by knitting. This gives the sleeve the ability to stretch and conform to any shape of substrate or conduit, as well as any connecting flange or fitting. Knitting also allows the first filamentary members to be plated with the second filamentary members to conveniently position the first filamentary members predominantly on the inner surface during the manufacture of the sleeve.

The sleeve may be formed as a single or a double knit. For the double knit sleeve, the first and second filamentary members are knitted on separate needles to form a first knitted layer and a second knitted layer surrounded by the first knitted layer. The first knitted layer forms the inner surface and is predominantly formed of the heat-resistant first filamentary members. The layers may be knitted in the manner of a rib knit and the ends of the sleeve are finished off in knitted welts to prevent unraveling without the need for separate finishing steps such as sewing.

Sleeves according to the invention may be single tubes or may be bifurcated with multiple branch sections interknitted to accommodate bifurcated substrates.

The invention also includes a method of manufacturing a sleeve for covering an elongated substrate. The method comprises the steps of:

(A) interlacing a plurality of first filamentary members, having properties compatible with the substrate, with a plurality of second filamentary members, having properties different from the first filamentary members, to form an inner surface of the sleeve positionable to face and surround the elongated substrate, and an outer surface positionable to face away therefrom; and

(B) positioning the first filamentary members predominantly on the inner surface.

Preferably, the interlacing step comprises knitting the first and second filamentary members, and the positioning step comprises plating the first filamentary members with the second filamentary members to achieve the desired location of the first filamentary members on the inside surface of the sleeve.

It is an object of the invention to provide a sleeve for covering a substrate, the sleeve having an inside surface predominantly formed of filamentary members which have properties compatible with the substrate.

It is a further object of the invention to provide a sleeve for covering a substrate, the sleeve having an outside surface predominantly formed of filamentary members which have properties different from the properties of the filamentary members forming the inside surface of the sleeve.

It is also an object of the invention to provide a heat-resistant sleeve for insulating substrates such as EGR conduits, which form elongated heat sources.

It is another object of the invention to provide a heat-resistant sleeve comprised of interlaced filamentary members.

It is again another object of the invention to provide a heat-resistant sleeve which can withstand sustained vibration environments.

It is yet another object of the invention to provide a heat-resistant sleeve which is flexible and stretchable and able to conform closely to the shape of the heat source.

It is still another object of the invention to provide a heat-resistant sleeve which can be manufactured to have more or less bulk as required for a particular application.

These and other objects and advantages of the invention will be apparent upon consideration of the following drawings and detailed description of the preferred embodiments.

### BRIEF DESCRIPTION OF THE DRAWINGS

FIG. 1 is a side view, partially cut away, of a heat-resistant sleeve according to the invention;

FIG. 2 is a side view, also partially cut away, of a bifurcated heat-resistant sleeve according to the invention;

FIG. 3 is a detailed view of a single knit plated stitch used to form sleeves according to the invention;

FIG. 4 is a detailed view of a double knit plated stitch used to form sleeves according to the invention; and

FIG. 5 is a partially cut-away perspective view of another embodiment of a protective sleeve according to the invention.

### DETAILED DESCRIPTION OF THE PREFERRED EMBODIMENTS

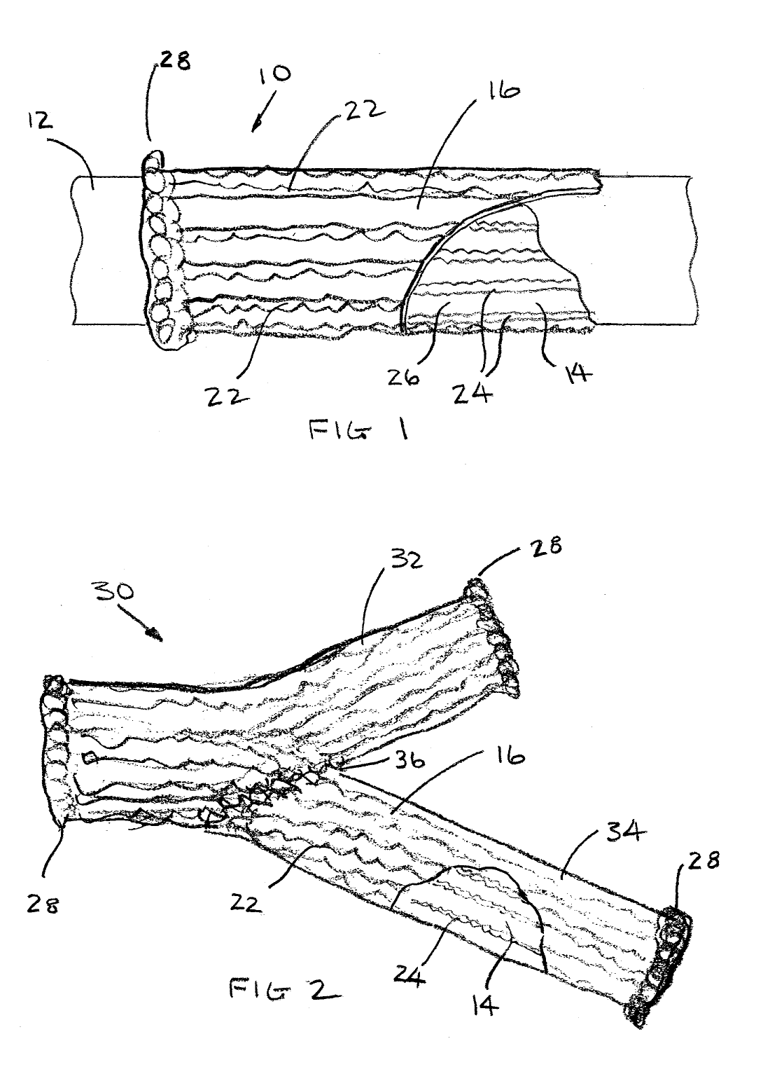

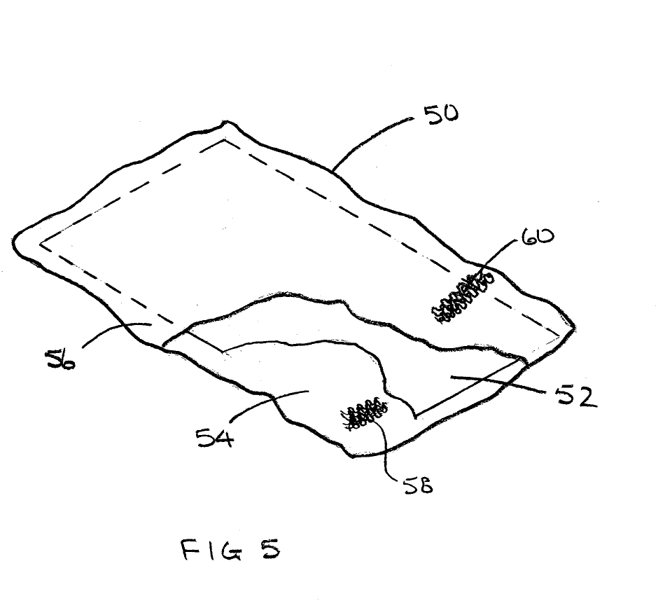

FIG. 1 shows a sleeve 10 according to the invention suitable for insulating elongated heat sources, such as an EGR conduit 12 on an internal combustion engine. Sleeve 10 has an inner surface 14 positioned to face the conduit 12 and an outer surface 16 which faces away from the conduit or other heat source. Sleeve 10 is preferably knitted from at least two different types of filamentary members 18 and 20 as shown in FIGS. 3 and 4 and described in detail below.

A plurality of ribs 22 and 24 may be knitted on the outer surface 16 and/or on the inner surface 14 of the sleeve 10. When knitted on the outer surface, the ribs 22 act as bumpers to protect the EGR conduit and cushion it from impact damage. Ribs 24, placed on the inner surface 14, provide added insulation by forming a series of longitudinal air pockets 26 between the sleeve 10 and the EGR conduit 12. The ribs 24 also reduce the contact area between the conduit and the sleeve, thus providing additional insulation against conductive heat transfer. The ribs 22 and 24 are integrally formed in the sleeve by a rib knit stitch as is well known in the art. The ends of sleeve 10 are finished by integrally knitting welts 28 to prevent unraveling of the sleeve.

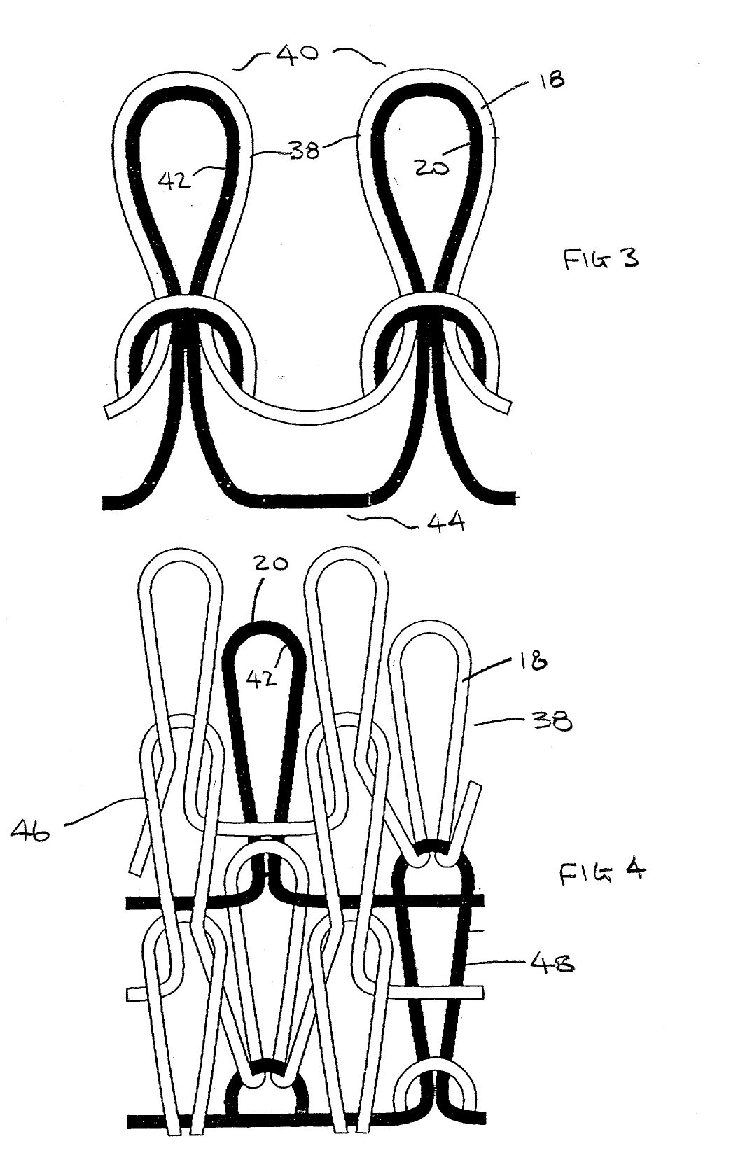

FIG. 2 shows an example of a bifurcated sleeve 30 according to the invention. Bifurcated sleeve 30 is similar to the single sleeve 10 in that it is knitted from at least two different types of filamentary members, has an inner surface 14 and an outer surface 16, may have integrally knitted internal and/or external ribs 24 and 22 and ends finished with welts 28. Sleeve 30 is bifurcated into two separate sleeve portions 32 and 34 which separate at a bifurcation point 36. Sleeve segments 32 and 34 are preferably integrally knitted as part of sleeve 30 by varying the size and density of the stitches in the region of the bifurcation to effect the separation of the sleeve segments as is known in the art.

Sleeves such as 10 and 30 according to the invention are preferably knitted because knitting provides several distinct advantages over other forms of interlacing filamentary members such as weaving and braiding, as well as over non-woven coverings such as felts or homogeneous coverings of extruded or molded plastics. Knitted structures have great flexibility and can expand or contract as needed to readily conform to complex curves without kinking as may be required to follow a tortuous EGR conduit snaking through an engine compartment from exhaust to intake manifold. Knitted structures have great elasticity and resilience which allows them to be stretched over tubing of various diameters and hug the outer surface of the conduit in a form fitting manner, automatically adjusting to changes in shape at any section along the conduit. This allows the sleeve to accommodate flanges, valves or other irregular features of the EGR system without the need to customize the sleeve for a particular shape. Knitted structures are also able to withstand harsh vibration without fear of fatigue failure. Furthermore, knitted items may be produced rapidly and relatively inexpensively on modern, programable high-speed knitting machines.

Sleeves such as 10 and 30 are preferably knitted using at least two different filamentary members 18 and 20 as shown in FIGS. 3 and 4. FIG. 3 shows a single knit configuration and FIG. 4 illustrates a double knit. There are various advantages to both single and double knits as described below. Regardless of the knit used, filamentary member 18 is plated with filamentary member 20 in the knit structure. Plating in the single knit design of FIG. 3 is achieved by knitting both filamentary members on the same needle and forcing one filamentary member 18 to the tip of the needle and the other filamentary member 20 to the back of the needle by means of a feed mechanism mounted on the knitting machine. This results in loops 38 of filamentary members 18 being positioned predominantly on one face 40 of the knit structure while the other filamentary member 20 forms loops 42 and is positioned predominantly on the opposite face 44 of the knit structure. Thus, with the single knit, a single fabric layer may be formed having opposite faces 40 and 44 with different physical characteristics depending upon the characteristics of the filamentary members 18 and 20 chosen for the knit.

In the example of a sleeve for the EGR conduit, filamentary member 18 is made of materials such as silica, glass, ceramic, stainless steel or bi-component DREF yarns where both components of the yarn are resistant to high temperatures. An example of a suitable DREF yarn would have a glass fiber core with a silica fiber covering. Prototype sleeves according to the invention have been fabricated using commercially available DREF yarns having a glass fiber core with a para-aramid fiber covering that has a relatively high elastic modulus and tensile strength with excellent heat and chemical resistance. Thermal decomposition of this yarn begins at about 932° F. The yarn maintains more than half of its room temperature strength at temperatures as high as 482° F. Ignition temperature of the yarn is about 1202° F. which can withstand relatively high temperatures.

During knitting, loops 38 of the filamentary members 18 are arranged predominantly on the inner surface 14 of sleeve 10 or 30. Thus, the filamentary member better able to withstand high temperature is arranged adjacent to the heat source surrounded by the sleeve. The filamentary members 20 which form loops 42 are arranged predominantly on the outer surface 16. The outer surface filamentary members 20 may be chosen from among materials such as aramids, various nylon formulations, polyester, polypropylene, as well as other materials such as stainless steel, nitinol, elgiloy or other materials having high tensile strength, fatigue strength, relatively great resistance to abrasion or impact damage or noise damping qualities in order to provide protection to the sleeve and conduit against a harsh environment such as the engine compartment of an automobile. Bi-component yarns, especially DREF yarns, are also feasible. For the example sleeve for EGR conduit, a preferred material for the filamentary members 20 is oxidized pan fiber (OPF). OPF is a modified acrylic fiber heated at low temperature (less than 300° C.) in an oxygen atmosphere to produce a highly thermally resistant, infusable fiber with a well oriented polymer structure having a carbon content of about 60%. OPF combines high strength characteristics with excellent heat resistance and insulating properties appropriate for a high temperature application such as sleeving for an EGR conduit.

The single knit design allows multiple characteristics to be present in a single layer sleeve, thus, reducing bulk and weight of the sleeve and allowing it to be used on conduits of relatively small diameter or over curves having relatively small bend radii.

In the double knit design illustrated in FIG. 4, the filamentary members 18 and 20 are plated by knitting the different filamentary members on separate needles. This yields two separate interknitted layers of material, 46 and 48. On layer 46, loops 38 of filamentary member 18 predominate, whereas on layer 48, loops 42 of filamentary member 20 predominate. Thus, each layer has distinct properties associated with the characteristics of the particular filamentary member forming the predominating loops.

For the double knit EGR sleeve, layer 46 may be arranged as an inner layer comprising inner surface 14, and layer 48 is then arranged as an outer layer comprising outer surface 16. Inner layer 46 is preferably formed of loops 38 of filamentary member 18, made from heat-resistant materials such as silica, glass, ceramic, stainless steel or bi-component DREF yarns where both components of the yarn are resistant to high temperatures. Outer layer 48 may be formed of loops 42 of filamentary member 20 formed of material having high tensile strength such as aramid fiber. The two layer design of the double knit, although heavier and bulkier than the single knit, can provide better isolation between the interior and exterior of the sleeve since there are two distinct layers which cover the entire surface of the heat source.

The operational temperature of the EGR conduit will often determine the choice of material for filamentary member 18. Silica yarn or filament provides protection against temperatures as high as 1832° F. Glass fibers also provide significant thermal protection on the order of 1022° F. Specially fabricated nylon fibers, sold under the commercial brand name “Nomex”, are useful for temperatures of 572° F. or lower.

FIG. 5 shows another example of a knitted sleeve 50 according to the invention. Sleeve 50 is a cover for automotive glass products such as a windshield 52 and is used to protect the windshield during transport and handling prior to installation. The inner surface 54 of sleeve 50 should be compatible with the glass windshield 52 in that the sleeve should not scratch or adhere to the glass. The outer surface 56 need not have these properties, but it may be advantageous to impart other properties to the sleeve such as durability, tensile strength and resistance to abrasion so that the windshield will be effectively protected and the sleeve 50 will be reusable.

A sleeve such as 50 can be knitted according to the invention using low-friction, non-stick filamentary members 58 made, for example, from polytetrafluoroethylene, the filamentary members 58 being positioned predominantly on the inner surface 54 of the sleeve 50. Such filamentary members are compatible with the glass substrate in that they will not scratch the glass or adhere to it. To provide durability to the sleeve 50, the filamentary members 58 are knitted with durable, high-strength filaments 60 made from multifilament aramid fibers, for example. This imparts durability and abrasion resistance to the sleeve 50. Knitting the sleeve allows the filamentary members 58 and 60 to be plated so that filamentary members 58 are predominantly positioned on the inner surface 54 of the sleeve and the filamentary members 60 are predominantly on the outer surface 56 of the sleeve.

The knit design, whether single or double knit, allows the sleeve to have greater bulk where necessary, to compensate for higher temperatures or higher mechanical or thermally induced stresses. The bulk of the knit design is increased by overfeeding one or the other of filamentary members 18 or 20 as necessary to form extended loops analogous to the knap found in terry cloth.

Production of the sleeve according to the invention is preferably by means of a double cylinder knitting machine with multiple feeds and having electronic control for forming ribs and end welts. A non-reciprocating machine could be used since, unlike hosiery, no heel or toe need be formed.

Knitted protective sleeving formed of filamentary members having different properties according to the invention provides a covering which is readily adaptable to almost any shape or configuration and places the filamentary member chosen for its specific properties where it will be most effective, thus, affording the most economical and efficient use of material.

What is claimed is:

1. A sleeve for covering an elongated substrate, said sleeve comprising an inner surface positionable to face and surround the substrate and an outer surface positionable to face away therefrom, said sleeve being formed from a plurality of first filamentary members having properties compatible with said substrate and interlaced with a plurality of second filamentary members having properties different from said first filamentary members, said first filamentary members being positioned predominantly on said inner surface for engaging said substrate, and said second filamentary members being positioned substantially on said outer surface.

2. A sleeve according to claim 1, wherein said first and second filamentary members are interlaced by knitting.

3. A sleeve according to claim 2, wherein said first filamentary members are plated with said second filamentary members thereby positioning said first filamentary members predominantly on said inner surface.

4. A sleeve according to claim 3, knitted with a single knit stitch thereby providing a relatively small bulk to said sleeve.

5. A sleeve according to claim 3, knitted with a double knit stitch thereby providing a relatively large bulk to said sleeve.

6. A sleeve according to claim 1, wherein said first filamentary members are formed from a heat-resistant material.

7. A sleeve according to claim 6 wherein said heat-resistant material is selected from the group consisting of silicon, glass, ceramic and stainless steel.

8. A sleeve according to claim 1, wherein said first filamentary members comprise heat-resistant DREF yarns having a glass fiber core with a silicon fiber coating.

9. A sleeve according to claim 1, wherein said first filamentary members comprise heat-resistant DREF yarns having a glass fiber core with an aramid fiber coating.

10. A sleeve according to claim 1, wherein said first filamentary members comprise a low-friction material.

11. A sleeve according to claim 10, wherein said low-friction material is polytetrafluoroethylene.

12. A sleeve according to claim 1, wherein said second filamentary members are made from a material having a relatively high tensile strength.

13. A sleeve according to claim 12, wherein said high tensile strength material is selected from the group consisting of aramid fibers and metal filaments.

14. A sleeve according to claim 1, wherein said second filamentary members are made from a material having relatively high abrasion resistance.

15. A sleeve according to claim 14, wherein said material comprises aramid fibers.

16. A sleeve according to claim 2, wherein said first and second filamentary members are knitted to form a plurality of ribs extending lengthwise along said sleeve.

17. A sleeve according to claim 16, wherein said ribs are positioned on said inner surface.

18. A sleeve according to claim 17, wherein said ribs are positioned on said outer surface.

19. A sleeve according to claim 2, wherein said sleeve is a bifurcated sleeve.

20. A sleeve according to claim 2, comprising at least one end knitted in the form of a circumferential welt.

21. A sleeve for covering an elongated heat source, said sleeve comprising an inner surface positionable to face and surround the heat source and an outer surface positionable to face away therefrom, said sleeve being formed from a plurality of heat-resistant first filamentary members interlaced with a plurality of second filamentary members, said heat-resistant first filamentary members being positioned predominantly on said inner surface for engaging said heat source, and said second filamentary members being positioned substantially on said outer surface.

22. A sleeve according to claim 21 wherein said first filamentary members are formed from heat-resistant material selected from the group consisting of silicon, glass, ceramic and stainless steel.

23. A sleeve according to claim 21 wherein said first filamentary members comprise heat-resistant DREF yarns having a glass fiber core with a silicon fiber coating.

24. A sleeve according to claim 21, wherein said second filamentary members are formed from heat resistant material selected from the group consisting of aramid fibers and oxidized pan fibers.

25. A method of manufacturing a sleeve for covering an elongated substrate, said method comprising the steps of:
interlacing a plurality of first filamentary members, having properties compatible with said substrate, with a plurality of second filamentary members, having properties different from said first filamentary members, to form an inner surface positionable to face and surround the substrate, and an outer surface positionable to face away therefrom; and
positioning said first filamentary members predominantly on said inner surface.

26. A method according to claim 25, wherein said interlacing step comprises knitting said first and second filamentary members.

27. A method according to claim 26, wherein said positioning step comprises plating said first filamentary members with said second filamentary members.

28. A method according to claim 26, wherein said first and second filamentary members are knitted together using a single knit stitch.

29. A method according to claim 26, wherein said first and second filamentary members are knitted together using a double knit stitch.
